(19) United States
(12) Patent Application Publication
(10) Pub. No.: US 2012/0135288 A1
(43) Pub. Date: May 31, 2012

(54) GALVANIC CELL HAVING A FRAME AND METHOD FOR THE PRODUCTION OF SAID GALVANIC CELL

(75) Inventor: Jens Meintschel, Bernsdorf (DE)

(73) Assignee: LI-TEC BATTERY GMBH, Kamenz (DE)

(21) Appl. No.: 13/203,252

(22) PCT Filed: Mar. 1, 2010
(86) PCT No.: PCT/EP2010/001260

§ 371 Date: Feb. 8, 2012

(30) Foreign Application Priority Data
Feb. 27, 2009 (DE) 10 2009 010 794.0

(51) Int. Cl. H01M 2/10; H01M 10/04

(52) U.S. Cl. 429/100; 29/623.1

(57) ABSTRACT

A frame for a galvanic cell, comprising an electrode stack with a foil-like packaging through which at least two conductors protrude, which is configured such that said frame can be firmly connected to the packaging of the cell during the manufacture of the cell. During the manufacture of such a galvanic cell, in the process of closing the packaging, a frame is firmly connected to the packaging.

Priority application 10 2009 010 794 as filed on Feb. 27, 2009 is fully incorporated by reference herein.

The present invention relates to a galvanic cell with a frame, and a method for its manufacture. Flat and rectangular cells (battery cells, capacitors, etc.) are known, whose electrochemically active content is surrounded by a foil-like packaging, for example, a thin aluminum foil, which may be coated on both sides with plastic, and through which electrical connectors are inserted in sheet form (so-called “conductors”). In contrast to other cell types, the packaging of such cells is not electrically conductive, since the conductors are inserted through the packaging so that they are insulated in respect to said packaging. Battery cells designed this way are also referred to as pouch or coffee-bag cells.

For various applications, e.g. in electric or hybrid vehicles, individual galvanic cells are arranged in series and/or in parallel and are usually arranged in a housing, often together with the respective electronics. Due to the prevailing lack of high mechanical strength of such pouch cells, which are welded into a foil, these cells often cannot be incorporated directly into a battery housing, but first have to be mechanically stabilized by appropriate supporting structures.

The present invention has the objective to facilitate the use and the handling of galvanic cells and to reduce or preferably to solve the problems that are associated with the sensitive nature of the packaging foil. This objective is solved by a product or by a method according to the independent claims.

According to the present invention, a frame is provided for a galvanic cell. The cell essentially comprises an electrode stack and a foil-like packaging, through which at least two conductors protrude. The frame is configured such that it can be firmly connected to the packaging of the cell during the manufacture of the cell. According to the method for manufacture of a galvanic cell according to the present invention, a frame is firmly connected to the packaging, when sealing/closing said packaging.

In the following, several terms are explained, which will be used in the subsequent description of the invention.

The term electrode stack is used to refer to the electrochemically active part of a galvanic cell of any type. In contrast, the packaging of a cell refers to the material that is not involved in the electrochemical reaction. Said packaging seals the electrode stack in respect to the environment.

In this context, whenever reference is made to a foil-like packaging, all types of packaging or surroundings are included, which fulfill the purpose to insulate and protect the electrode stack effectively against the environment, preferably under low material use. The insulation/protection shall be effective in respect to any transfer of matter and in respect to electric currents. This term also includes, but is not limited to foils in the common understanding, in particular, also plastic-coated metal foils.

A conductor according to the present invention refers to an electrical conductor/connection, which protrudes through the packaging to the outside, so that a transport of electrical charge into the cell or from the cell may occur.

A frame according to the present invention refers to any device/part, which is suitable to stabilize the cell mechanically against influences from the outside, and which can be firmly connected to the packaging of the cell during the manufacture of the cell. As already indicated by the word, a frame is preferably a substantially frame-shaped device/part, whose function is substantially based on providing mechanical stability to a galvanic cell. Advantageous embodiments of the invention follow from the dependent claims.

In the following, the invention is described in more detail, based on preferred embodiments and with the aid of figures.

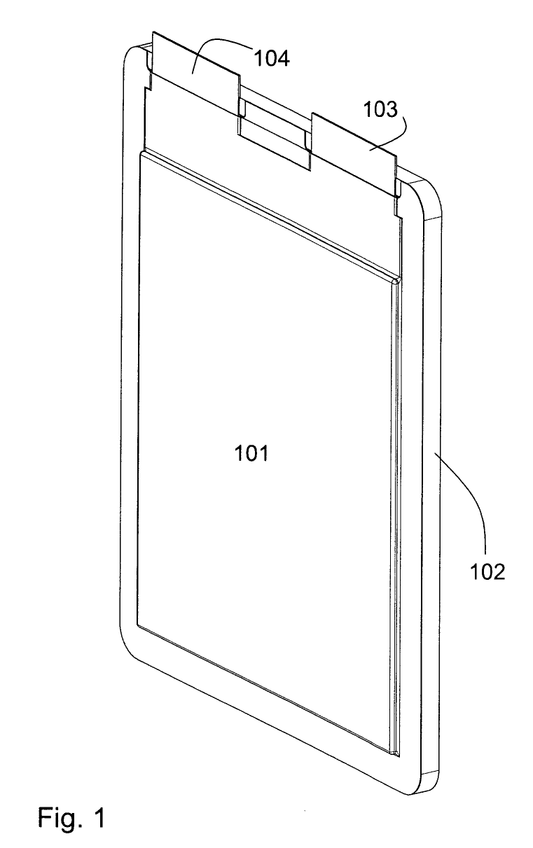

FIG. 1 shows a front view of an embodiment of a cell according to the invention having an integrated frame;

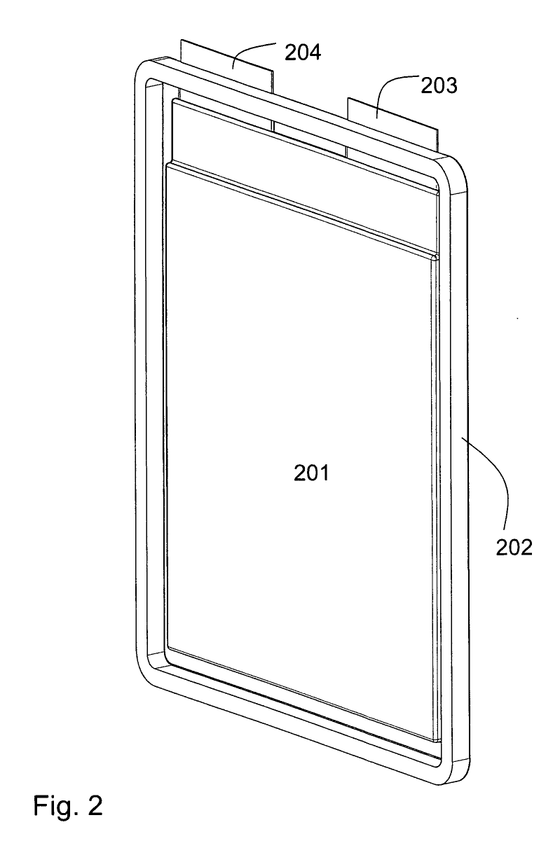

FIG. 2 shows a rear view of the same embodiment;

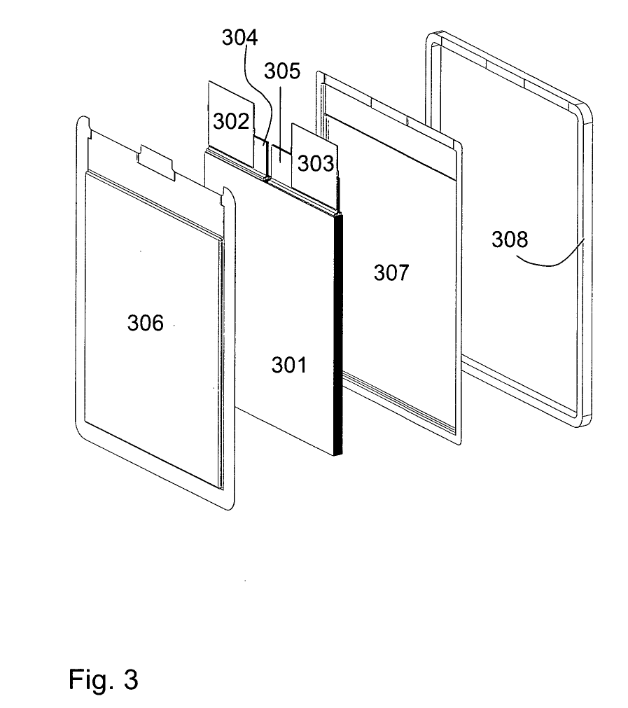

FIG. 3 shows an exploded front view of said cell, and

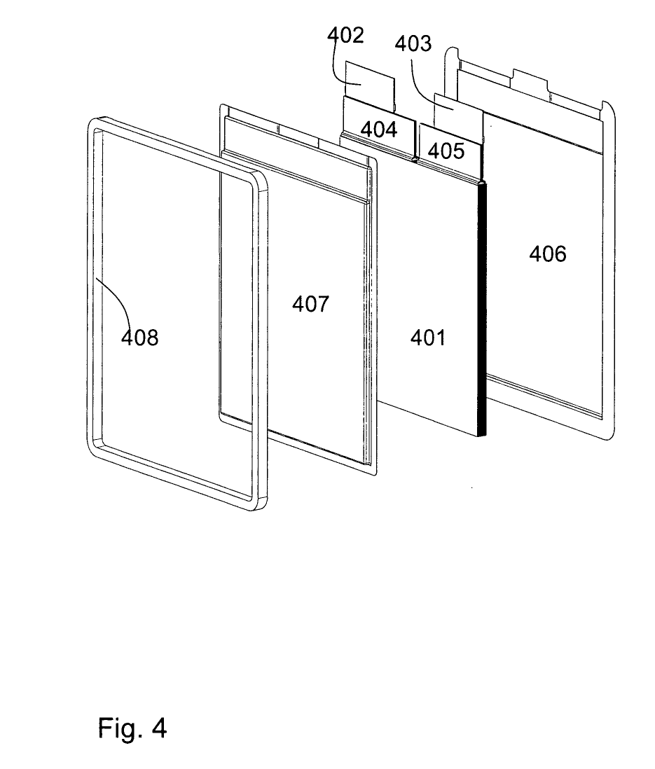

FIG. 4 shows an exploded rear view of said cell;

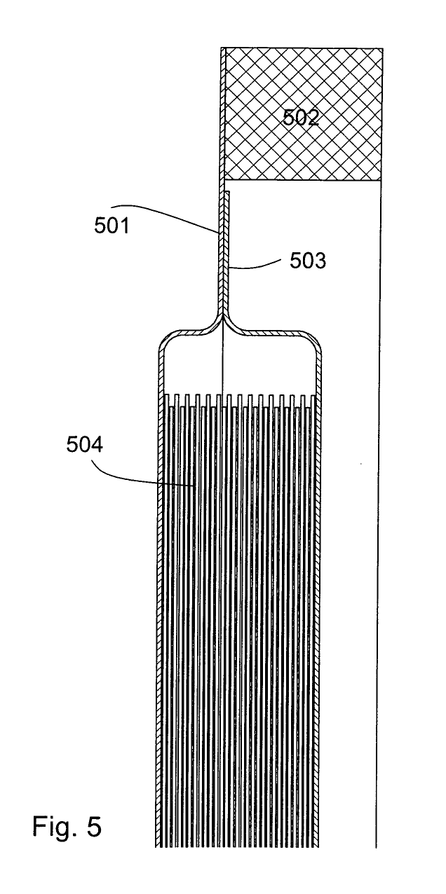

FIG. 5 shows an embodiment of the invention, in which the frame is welded to the inside of the packaging foil, which is extended to the outside;

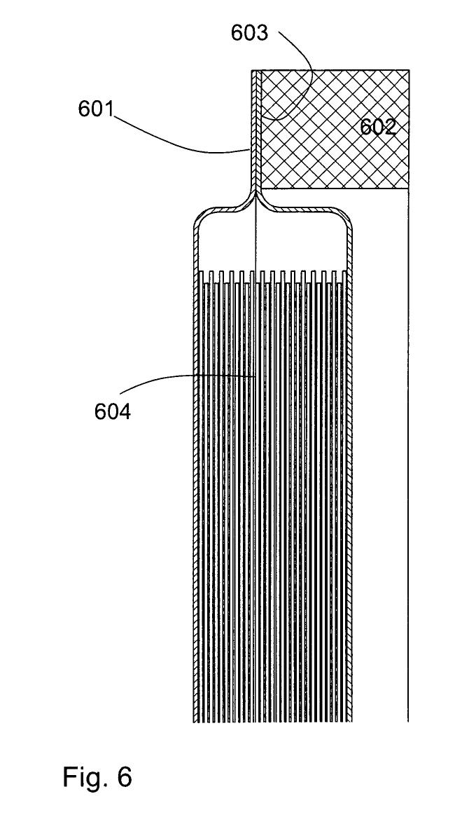

FIG. 6 shows an embodiment of the invention, in which the frame is welded to the outside of the packaging foil in the area of the sealing of the two foils;

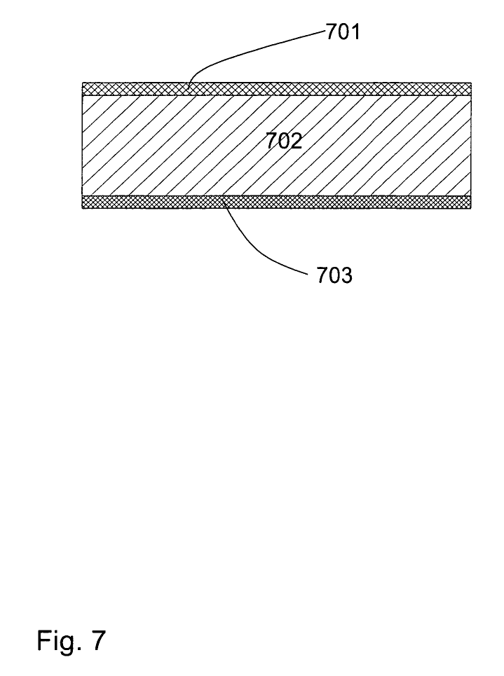

FIG. 7 shows the basic structure of a typical packaging foil for galvanic cells;

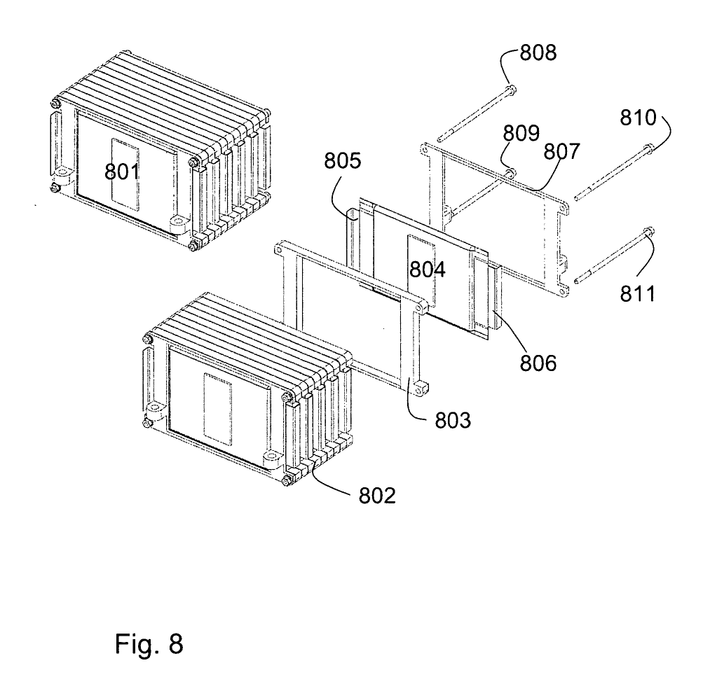

FIG. 8 shows the structure of a cell block of galvanic cells according to one embodiment of the present invention;

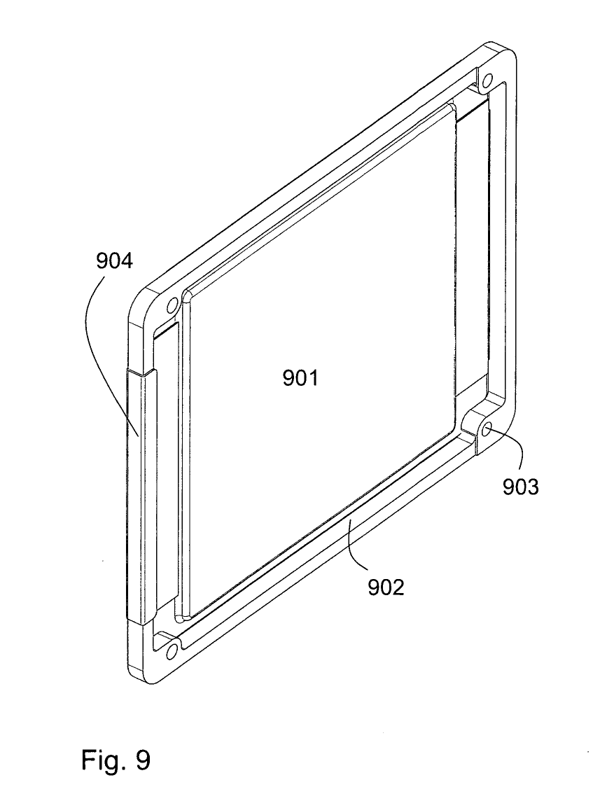

FIG. 9 shows a view of a galvanic cell according to one embodiment of the present invention, with a frame having holes for an anchor rod, and having conductors, which are partially bent around the frame and are contacted and fitted by force;

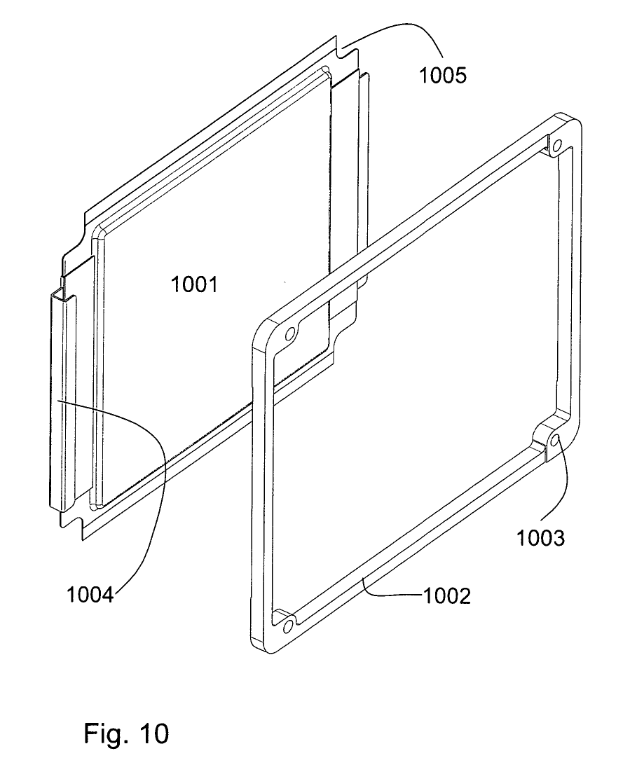

FIG. 10 shows an exploded view of the cell, which is illustrated in FIG. 9;

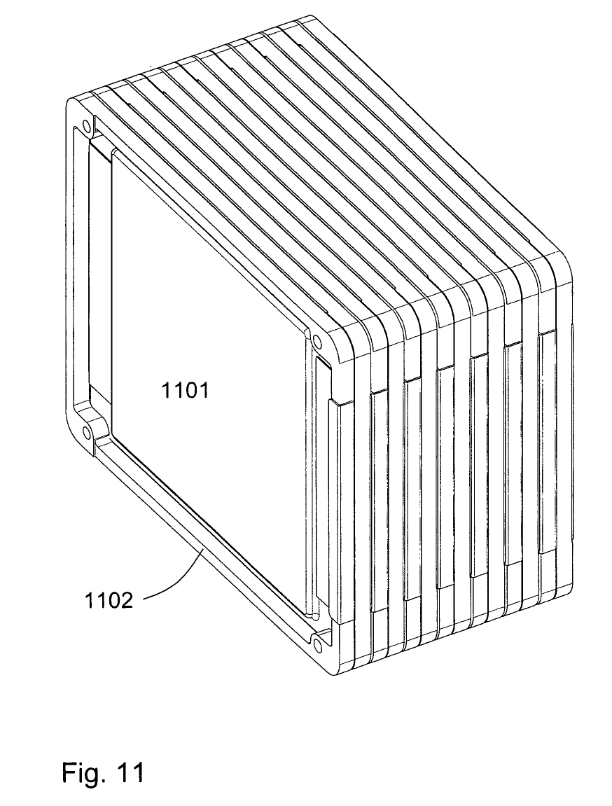

FIG. 11 shows a view of a cell block of individual cells, wherein the anchor rod is not shown;

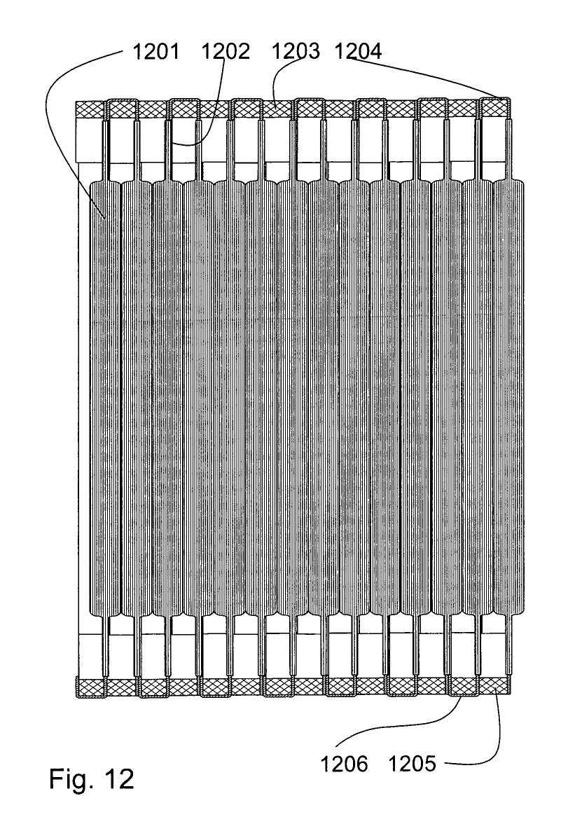

FIG. 12 shows a sectional view of the cell block illustrated in FIG. 11;

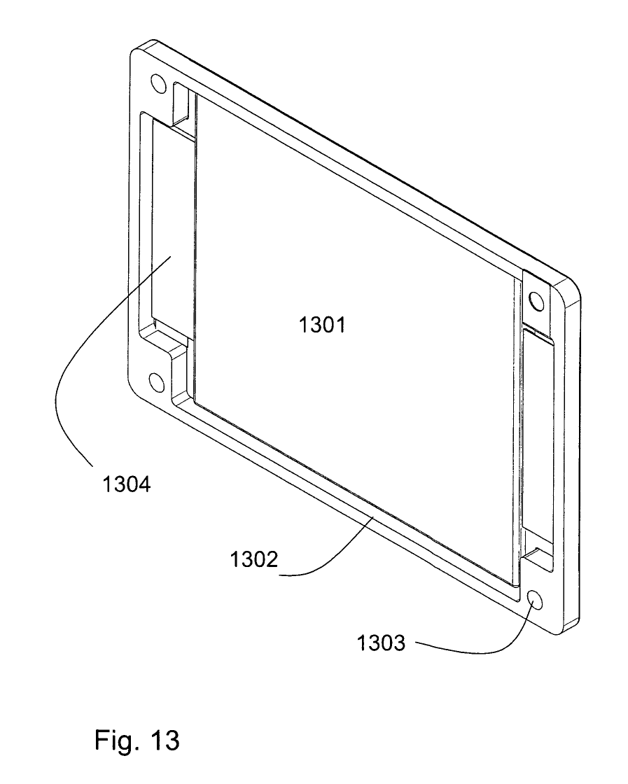

FIG. 13 shows a view of a cell according to the invention and according to another embodiment, wherein the conductors protrude in parallel through the welding seam of the foil, and which are contacted and fitted by force;

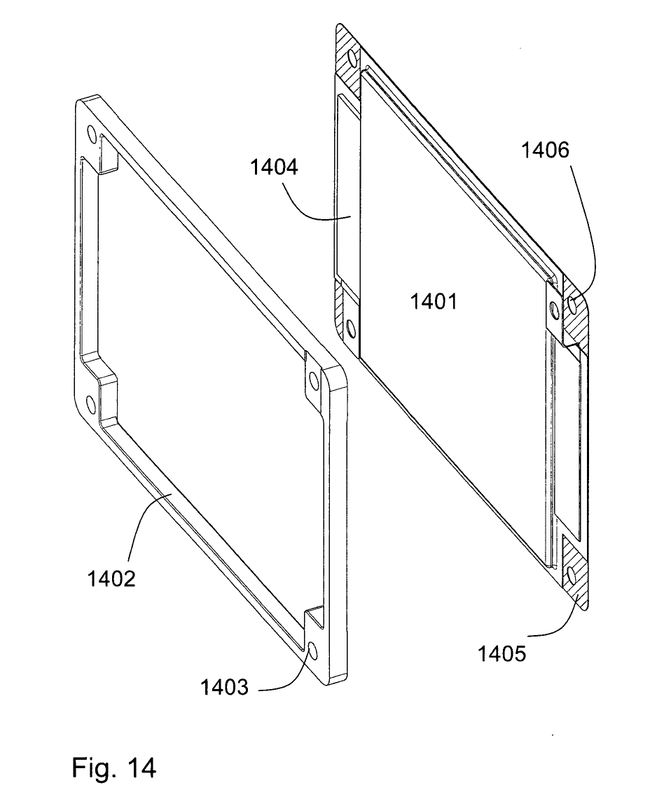

FIG. 14 shows an exploded view of the cell, which is illustrated in FIG. 13;

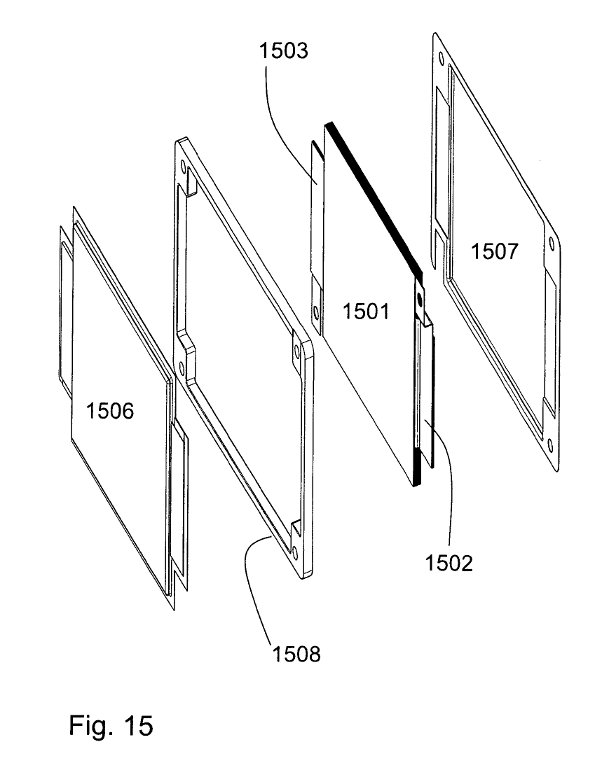

FIG. 15 shows an additional exploded view of said cell;

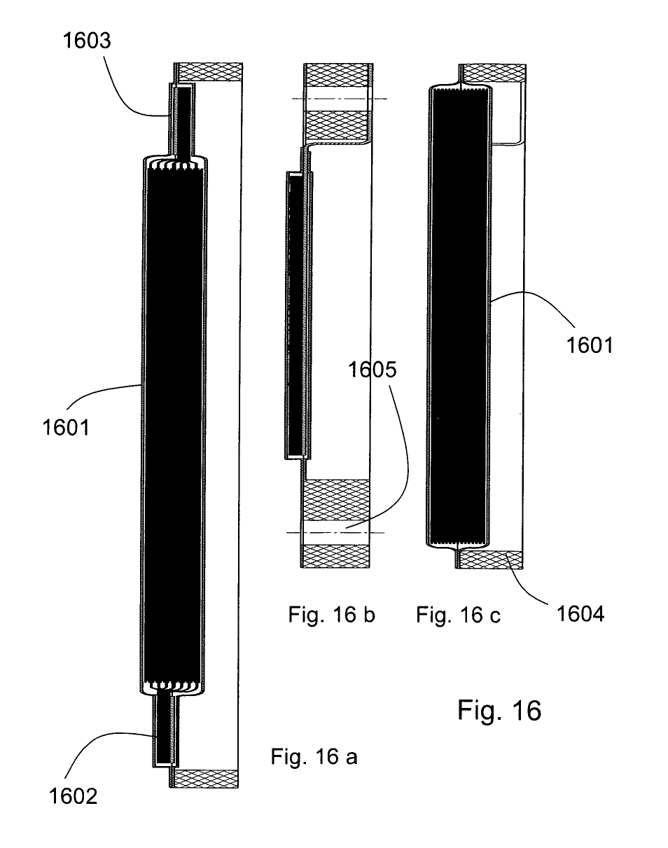

FIG. 16 shows various sectional views of a galvanic cell according to one embodiment of the invention and a sketch of the sectional lines;

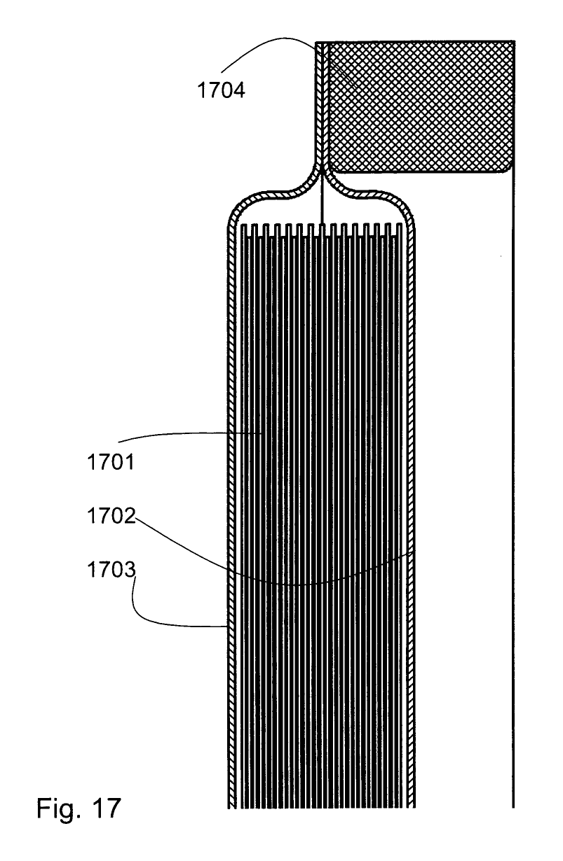

FIG. 17 shows a sectional view of a cell according to an embodiment of the invention with an enlargement of the frame area;

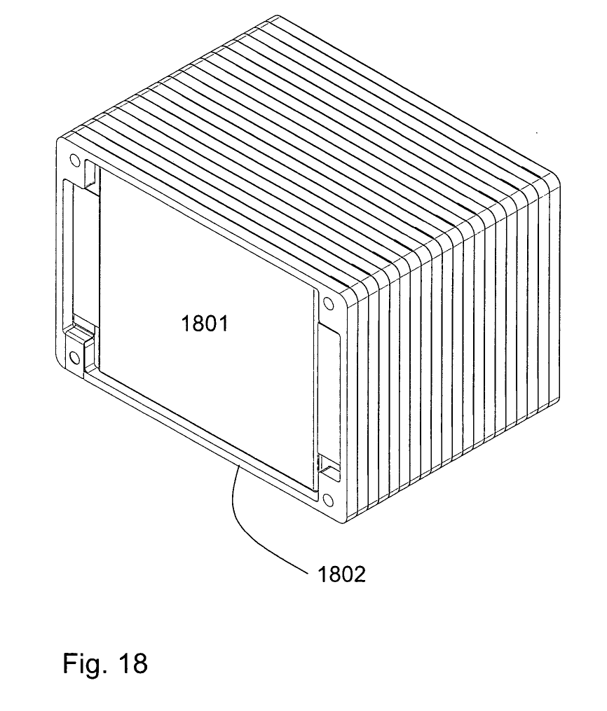

FIG. 18 shows a cell block of cells according to FIG. 13;

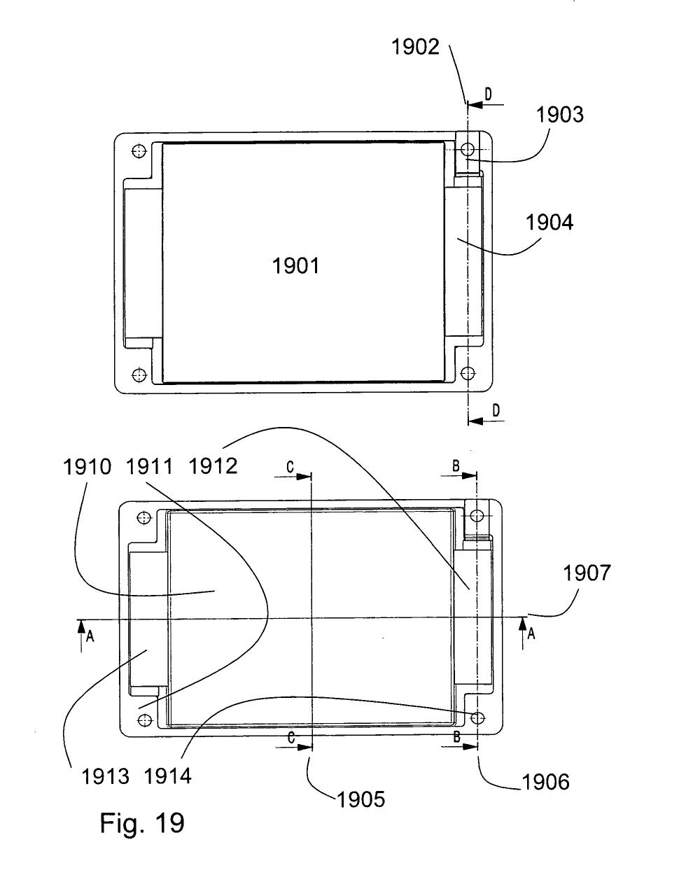

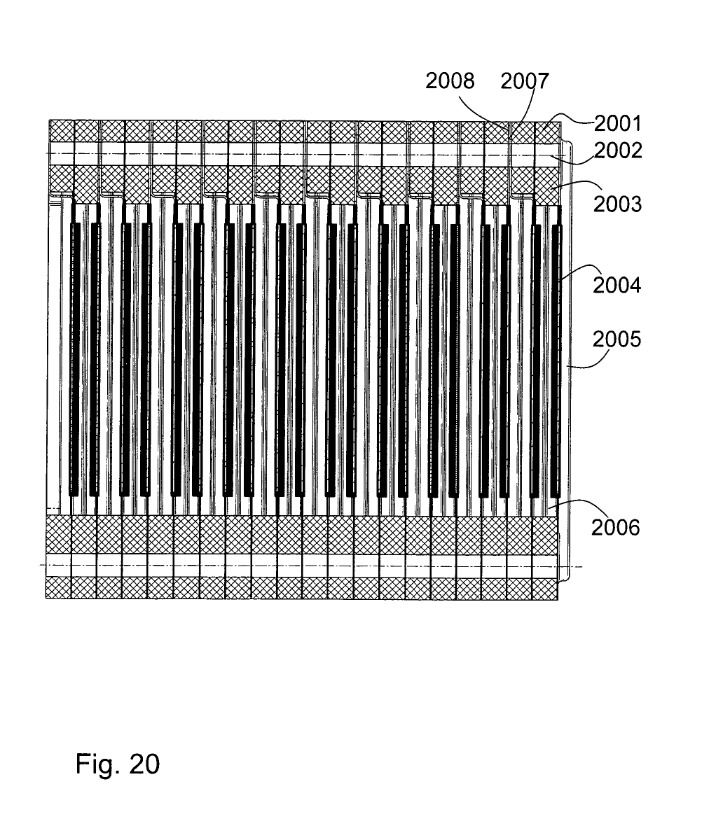

FIG. 19 shows a sketch of the sectional lines to illustrate the line along which the section depicted in FIG. 20 was cut, and an additional sketch of the sectional lines to illustrate along which lines the sections depicted in FIG. 16 were cut;

FIG. 20 shows a sectional view of the cell block, which is illustrated in FIG. 18, and

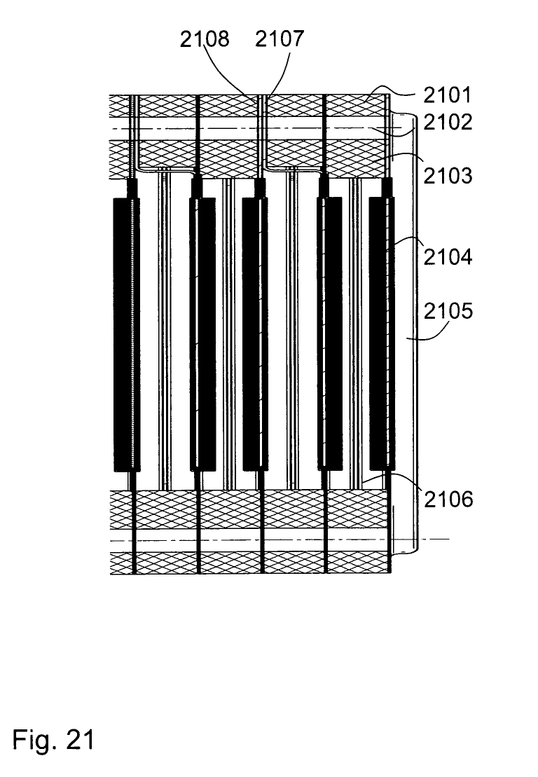

FIG. 21 shows an enlarged section of the illustration of FIG. 20.

The invention is based on a galvanic cell, essentially comprising an electrode stack and a foil-like packaging, through which at least two conductors protrude. According to the invention, such a galvanic cell is stabilized by a frame, which is configured such that said frame can be firmly connected to the packaging of the cell during the manufacture of the cell. Based on the respective set-up of the embodiments of the invention, it is advantageous that the galvanic cells are not just only stabilized when installed into a battery by means of a connection, which is established in this case to a frame or to a support, but that the cell is already stabilized by the frame according to the invention prior to the assembly into a cell block. The method according to the invention, according to which the frame is already connected to the cell when sealing/closing the packaging, has the additional advantage that already during the manufacturing processes, i.e. during the filling of the cell, during the formation, during ordinary aging of the cell, or during the so-called “grading”, the cell is already protected against mechanical influences.

Depending on the intended use, in order to implement the connection with the frame in accordance with the present invention, particular methods by material engagement, as for example, adhesion or similar methods are suitable. Preferably, the frame can also be connected to the packaging foil, which often is provided with a respectively suited layer, by means of hot pressing or hot sealing, which is preferably applied by means of partial melting of a thermoplastic layer provided between the joining parts, with subsequent cooling under pressure force.

The term “hot sealing” refers to a process for joining thermoplastic melt layers of packaging materials (e.g. composite foils), preferably by means of hot pressing. Hot sealing is an important method for welding foils used in packaging technology. Essentially, the following two methods may be distinguished:

a) sealing with a heating rod or a heating rule (“Heizlineal”) between sealing jaws, this is also known as contact sealing, and
b) pulse sealing.

In the first method a (preferably movable) sealing jaw supports a heated rod. A (preferably stationary) lower sealing jaw is often provided with a surface of an elastic material to compensate for irregularities of the sealing seam. Sealing elements of this type are used in many machines available on the market for the manufacture and for the sealing of bags, as well as in form of form, fill and sealing machines.

For very long sealing seams, the heating rods often must be manufactured to be extremely accurate and without any deviation, to ensure uniform pressure along the entire sealing surface. In order to achieve accurate sealing seams, the foils are often flattened with the aid of stretching devices prior to entering the sealing tool. Another option is the use of heating rods with a saw-like sealing surface, however, this is associated with the danger of causing perforations.

For the elastic surface of the stationary cold sealing jaw, silicone rubber has been proven to be useful. Often, this counter pressure bar is provided in a curved shape. During the sealing process, pressure initially builds up in the center of the sealing seam, which, when closing the tool, extends to the edges. This way, an optimum sealing seam may be created. In addition, small liquid droplets may be squeezed out of the sealing area, which otherwise could destroy the sealing seam by means of generating water vapor.

For the pulse sealing process, the temperature of the sealing beams is maintained for a comparatively short period of time and not over the entire sealing cycle. The required heat is generated by two small resistor elements on both sealing jaws.

Once the sealing tool is closed around the foil to be sealed, the welding process takes place by means of a short current pulse. Compared to the seals produced by heating rods, the time of heat exposure is shorter and excess heat is immediately conducted away. To prevent sticking of the sealed material, the sealing surface of the tool may additionally be covered by a thin insulating foil made of heat resistant material.

Mechanical stress peaks, which can easily arise when the device is under stress, can largely be avoided by means of attaching the packaging foil to the frame over a large-area. The connection to the frame may be provided via the inside of the packaging foil, which often is coated with polypropylene. FIG. 5 shows such a connection of the frame to the inside of the packaging foil. According to another embodiment of the invention, it is also envisioned to connect the frame with the outside of the packaging, which often is coated with polyamide. Such an embodiment according to the invention is shown in FIG. 6.

Furthermore, it is advantageous to perform the sealing of the cell, i.e. the connection of both parts of the packaging foil and the connection to the frame, in one step.

To simplify the assembly of a cell block of galvanic cells according to the invention, it is advantageous and therefore preferred to provide the frame with respective shape elements, such as, for example, protrusions or indentations which, for example, are arranged on two sides of the frame such, that the corresponding shape elements can engage with each other by means of form-fit, and thus, support the assembly of the cell block by supporting the intended orientation of the cells.

The frames according to the invention are preferably provided with drill-holes or with other through-holes at the appropriate places, through which anchor rods can be inserted, which then hold the cell block together.

FIGS. 1 to 4 show a preferred embodiment according to the invention, in which the frame is preferably made out of plastic and connected to the inside of a packaging foil by means of hot pressing. As shown in FIG. 5, in this embodiment, the part of the packing foil that is connected to the frame, protrudes the other part of the foil along the circumference.

FIG. 1 shows a three-dimensional view of a cell according to this embodiment with an integrated frame 102, which is connected to the packaging of the cell 103. The conductors 101 of the cell protrude through the packaging. FIG. 2 shows the same cell from the other side. Accordingly, reference numbers 201, 202, and 203 refer to the conductor, the frame, and the packaging of the cell. FIG. 3 shows an exploded view of said cell with an integrated frame. The cell stack 301, with which the head of the cell is electrically connected via its two electrode bundles 304, 305, and to which the conductors 302, 303 are attached, is enclosed on both sides by a packaging foil having the parts 306 and 307, which are mechanically stabilized by a frame 308. A corresponding exploded view from the other side is shown in FIG. 4. In this case again, electrode stack 401 comprises electrode bundles 404, 405, and conductors 402, 403 as attached thereto are enclosed and sealed by the two parts 406, 407 of the packaging foil as stabilized by frame 408.

The basic structure of a typical packaging foil for galvanic cells is shown in FIG. 7. An aluminum foil 702 is coated on one side with a polyamide 701 and on the other side with a polypropylene 703. Other foils with other materials, layers, or coatings are, of course, also included in the present invention.

A preferred embodiment of a cell block of galvanic cells according to the invention, having an integrated frame, is shown in FIG. 8. A complete cell block 801 is assembled by means of adding additional cells as, for example, cells with a frame and having the reference number 803, to a cell block 802 that is still under construction. Cell 803 consists of actual cell 804 with conductors 805, 806, which are connected in a force-fitted manner to frame 807. To stabilize the entire cell block, anchor rods 808, 809, 810, and 811 are inserted into the frame through corresponding through-holes.

In case frames are provided comprising structures as, for example, protrusions or grooves, which facilitate a centering or an alignment of the cells, the insertion of the anchor rods into the through-holes is significantly facilitated. In this embodiment, the conductors are folded or bent around the frame in a weight saving manner, which eliminates the need for a massive contact strip.

FIG. 9 shows a detailed view of such a cell with conductors, which are folded around the frame. Cell 901 comprises a conductor 904, which is folded around the frame 902. The frame is provided with a hole 903 for the insertion of anchor rods. FIG. 10 shows the same cell in an exploded view. Different from what is illustrated in the figure, conductor 1004 is only bent around the frame after the frame has been attached first. FIG. 11 shows a cell block of galvanic cells according to this embodiment.

FIG. 12 shows a sectional view of the cell block illustrated in FIG. 11. A conductor 1204 is attached to the head 1202 of a cell 1201, said conductor is bent around the frame 1205 and electrically contacted to a conductor of the adjacent cell. The opposite conductor of the cell 1201 is not bent around the frame 1205 and, therefore, electrically isolated from the conductor 1206 of the adjacent cell, which in turn is electrically contacted to a conductor of the next adjacent cell. Thereby, it is possible to achieve the desired electrical wiring of the conductors during assembly of the cell block virtually without additional means.

Even less space is required, in accordance with another embodiment according to the invention, which is shown in FIG. 13. The conductors 1304 of the cell 1301 protrude through the packaging in parallel to the welding seam and are contacted by force-fit. The frame 1302 has a through-hole 1303 for the insertion of an anchor rod. An exploded view of said embodiment is shown in FIG. 14. The packaging of the cell 1401 comprises specific areas 1405 on its corners, which are suited for hot pressing with the frame 1402. For this, the conductors 1404 of the cell are placed such that an intended contact occurs “automatically”. The corners of the packaging of the cell can additionally be provided with holes 1406 for the insertion of an anchor rod, said holes are placed in the frame 1402 so that the respective through-holes 1403 line up. An exploded view of this embodiment is shown in FIG. 15. Electrode stack 1501 with conductors 1502, 1503 is enclosed between an upper part 1506 of the packaging, a frame 1508, and a lower part 1507 of the packaging. The upper part and the lower part of the packaging comprise shape elements, which are illustrated in FIG. 15. These shape elements support an “automatic” contact/alignment of the connectors as intended.

FIG. 16 shows three different sections 16a, 16b, and 16c of a galvanic cell, indicated in the lower part of FIG. 19. FIG. 16a shows the section according to the cut along the line 1907, FIG. 16b shows the section according to the cut along the line 1906, and FIG. 16c shows the section according to the cut along the line 1905. FIG. 16a shows the cell stack 1601 with heads of cells 1602, and 1603. FIG. 16b shows the through-hole 1605 through the frame 1604 and FIG. 16c shows a section of the cell, which is perpendicular to FIG. 16a.

FIG. 17 shows an enlarged sectional view of the frame area of said embodiment according to the invention. Frame 1704, which is connected to both parts of the packaging foil 1702, 1703 of the cell 1701 is shown. FIG. 18 shows a cell stack of cells according to said embodiment of the invention. FIG. 20 shows a section of the cell block the cut being implemented along the line as illustrated in the upper part of FIG. 19. FIG. 19 shows an enlargement of a section from this sectional view, in which it is more apparent than in FIG. 20 that, in this embodiment of the invention, space is used even more efficiently. As seen in the upper part of FIG. 21, through special form design of the conductor 2107, which is electrically contacted to the conductor 2108 of the adjacent cell, an assembly of the cell block is possible nearly without any splits. Also illustrated are the cell stack 2104, the underside of the packaging 2105, the upper side of the packaging 2106, the frame 2101 or, respectively, 2103, and the through-hole 2102.

1.-12. (canceled)

13. A galvanic cell (901), which essentially comprises an electrode stack with a foil-like packaging, through which at least two conductors protrude, and which cell has a frame (902), which frame was firmly connected to the packaging of the cell during the closure of the packaging,
wherein
a) at least one conductor (904) is folded or bent around the frame such, that said conductor (904) electrically contacts to a conductor of another cell, which is adjacent during the assembly of a stack of such cells, and
b) at least another conductor is not folded or bent around said frame.

14. A frame for the galvanic cell according to claim 13, which is configured such, that it can be connected to the packaging of the cell by material engagement during the closure of the packaging.

15. The frame according to claim 14, which is configured such, that it can be connected to the packaging of the cell during the closure of the packaging by material engagement by means of a hot sealing process, without the addition of additional material.

16. The frame according to claim 15, comprising structures, that support an alignment of the cells, which comprise said frame, during the assembly of a cell block.

17. The frame according to claim 16, having through-holes for accommodating anchor rods for the assembly of a cell block.

18. A galvanic cell having the frame according to claim 14.

19. A method for the manufacture of a galvanic cell according to claim 18, wherein an electrode stack is enclosed by a foil-like packaging, through which at least two conductors protrude, characterized in that, when closing the packaging, a frame is firmly connected to the packaging, and that at least one of the conductors (1004) is bent around the frame after arranging the frame.

20. The method according to claim 19, wherein the frame is connected to the packaging by material engagement.

21. The method according to claim 20, wherein the frame is connected without the addition of additional material to the packaging of the cell by material engagement during the manufacture of the cell by means of a hot sealing process.

22. A method for the assembly of a block from a plurality of galvanic cells according to claim 18, wherein the cells are aligned with the aid of structures of said frame.

23. The method according to claim 22, wherein the block is stabilized with the aid of anchor rods, which are inserted through through-holes into the frame of the cells.
